(19) United States
(12) Patent Application Publication
(10) Pub. No.: US 2009/0067700 A1
(43) Pub. Date: Mar. 12, 2009

(54) Presentation of computer-aided detection/diagnosis (CAD) results

(75) Inventors: Peter Maton, Miamisburg, OH (US); Bruce Voorhees, Loveland, OH (US); Arghir Suciu, Dayton, OH (US); Steve W. Worrell, Beavercreek, OH (US); Sam D. Finkelstein, Canton, OH (US); David S. Fryd, St. Paul, MN (US); Kevin E. McBride, Roswell, GA (US)

Correspondence Address: CONNOLLY BOVE LODGE & HUTZ LLP, 1875 EYE STREET, N.W., SUITE 1100, WASHINGTON, DC, 20006, US

(73) Assignee: Riverain Medical Group, LLC, Miamisburg, OH (US)

(21) Appl. No.: 11/979,881

(22) Filed: Nov. 9, 2007

Related U.S. Application Data
(60) Provisional application No. 60/971,008, filed on Sep. 10, 2007.

(51) Int. Cl. G06K 9/00; G06K 9/34

(52) U.S. Cl. 382/132; 382/173

(57) ABSTRACT

A user may be provided with identified regions of interest superimposed on a larger image, which may permit the user to individually examine the regions of interest. The regions of interest may be independently windowed and/or leveled and/or magnified according to parameters associated with the region of interest, which parameters may be generated by a computer-aided detection algorithm.

### CROSS-REFERENCE TO RELATED APPLICATION

This application claims the priority of U.S. Provisional Patent Application No. 60/971,008, filed on Sept. 10, 2007, and incorporated herein by reference.

### FIELD OF ENDEAVOR

Various embodiments of the invention may relate, generally, to the presentation of computer-aided detection/diagnosis (CAD) results.

### BACKGROUND

Computer-aided detection/diagnosis (CAD) techniques show much promise as an aid to physicians. However, in general, a physician may often have only a very short time to review the results, and interaction with a computer system can affect the efficiency of the review.

Currently-known result display systems show the whole image, which requires the user to window/level the whole image to separately investigate each identified region of interest (ROI), and a magnifier (or panning or zoom) may be used to investigate the detail of each ROI. These current systems typically apply all parameters to the entire image, whereas different ROIs may have different optimal windowing/leveling parameters and/or magnification parameters. Consequently, the physician may have to repeatedly reset such parameters to investigate each identified ROI, which may take a considerable amount of time.

### BRIEF DESCRIPTIONS OF THE DRAWINGS

Various embodiments of the invention will now be described in conjunction with the accompanying drawings, in which:

FIG. 1 shows a conceptual flow diagram of various embodiments of the invention;

FIGS. 2A and 2B show various displays that may be included in various embodiments of the invention;

FIGS. 3A and 3B show further displays that may be included in various embodiments of the invention;

FIGS. 4A and 4B show yet further displays that may be included in various embodiments of the invention;

FIG. 4C conceptually demonstrates how multiple displays may exist in various embodiments of the invention;

FIG. 5 shows yet another display that may be included in various embodiments of the invention; and

FIG. 6 shows a system in which various embodiments of the invention may be fully or partially implemented.

### DETAILED DESCRIPTION OF VARIOUS EMBODIMENTS

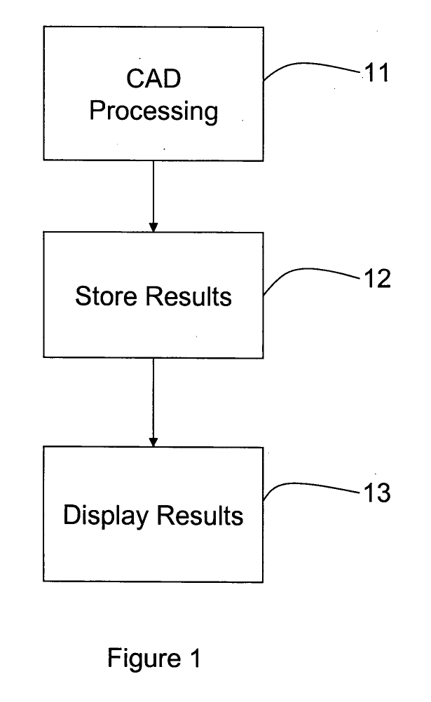

FIG. 1 shows an overview of an embodiment of the invention at the system level. An image may be input and may undergo CAD processing 11. The CAD results obtained in CAD processing 11 may be stored 12; alternatively, block 12 may be omitted. A storage medium to store the CAD results may be located locally or remotely from the other portions of the system. The CAD results may then be displayed to the user 13.

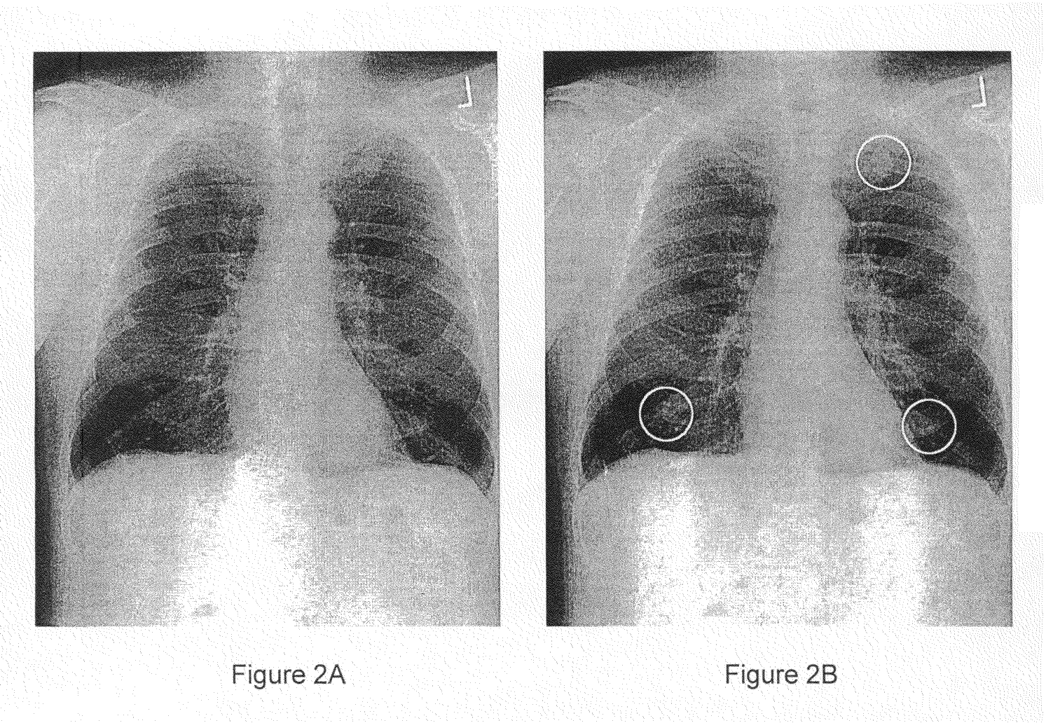

FIGS. 2A and 2B, respectively, show a chest image and a CAD results image corresponding to the chest image, which may be produced by various types of CAD techniques, and which may be used in various embodiments of the invention. One way of displaying CAD results may be to provide circles or other similar indicia (e.g., other geometric shapes, colorings, X's, etc.) of the ROI locations. In current systems, the user may then need to examine each individual ROI by varying windowing/leveling and/or magnification.

As an alternative to such indicia in some embodiments of the invention, on command from the radiologist to show the ROIs, each ROI may be presented as a magnified region with optimized windowing and leveling, which may be derived according to the features found by the CAD algorithm.

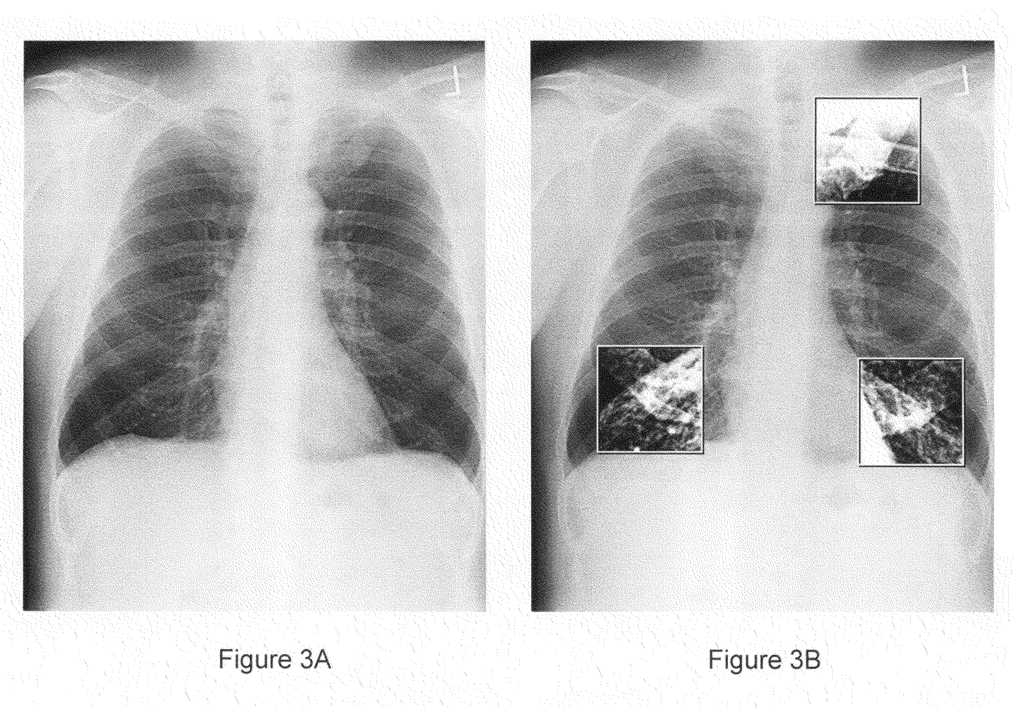

FIGS. 3A and 3B demonstrate such a display technique for a chest image. FIG. 3A is the raw chest image. FIG. 3B is a chest image with ROI “chips” superimposed on the raw chest image, rather than, for example, circles surrounding the ROIs. As shown in FIG. 3B, each ROI chip may be windowed/leveled and/or magnified according to parameters that may be automatically determined for the particular ROI. This may allow the user to more quickly review the ROIs, without having to adjust display parameters for each ROI.

It is further noted that this concept may be extended, in some embodiments of the invention, to show other registered image chips, such as those from dual-energy subtraction (DES), or CAD algorithm outputs, such as the determined ROI boundary, boundary of other adjacent detected features, certainty of nodularity (e.g. score), etc. In fact, the original ROIs to be superimposed or such other registered image chips may be other than CAD results. For example, they may correspond to ROIs entered by a user or input from some other non-CAD source.

In addition to the above, in some embodiments of the invention, the user may select a particular ROI chip and adjust its parameters (windowing, leveling, magnification, etc.) according to the user's preferences. This may be done, e.g., via the use of menus, sliding controls, or other graphical user interface (GUI) methods. Other processing and display parameters, such as inversion, brightness, etc., may also be user-selectable for a given ROI chip and/or for the entire image (with regard to the latter, the user may be able to select the entire image or portions of the entire image for such processing).

Some embodiments of the invention may permit multiple selectable image displays. For example, in some embodiments of the invention, the ROI chip mode may be activated by scrolling with the mouse wheel, by mouse clicks, or by keystrokes or button pushes on a user interface device (or, similarly, manipulations of a touch-screen display). For example, the user may be able to select among two or more of the following: the plain image (e.g., as shown in FIG. 2A or FIG. 3A), the image with indicia of ROIs (e.g., as shown in FIG. 2B), and the image with ROI chips shown (e.g., as shown in FIG. 3B). Furthermore, there may be additional options available for the user to select. For example, display parameters for the overall image and/or for all ROI chips or for individual ROI chips (as discussed above) may be optimized and reflected in the display. For example, FIG. 3B shows an exemplary display in which the display parameters for the overall image have been optimized (and similarly for each ROI chip).

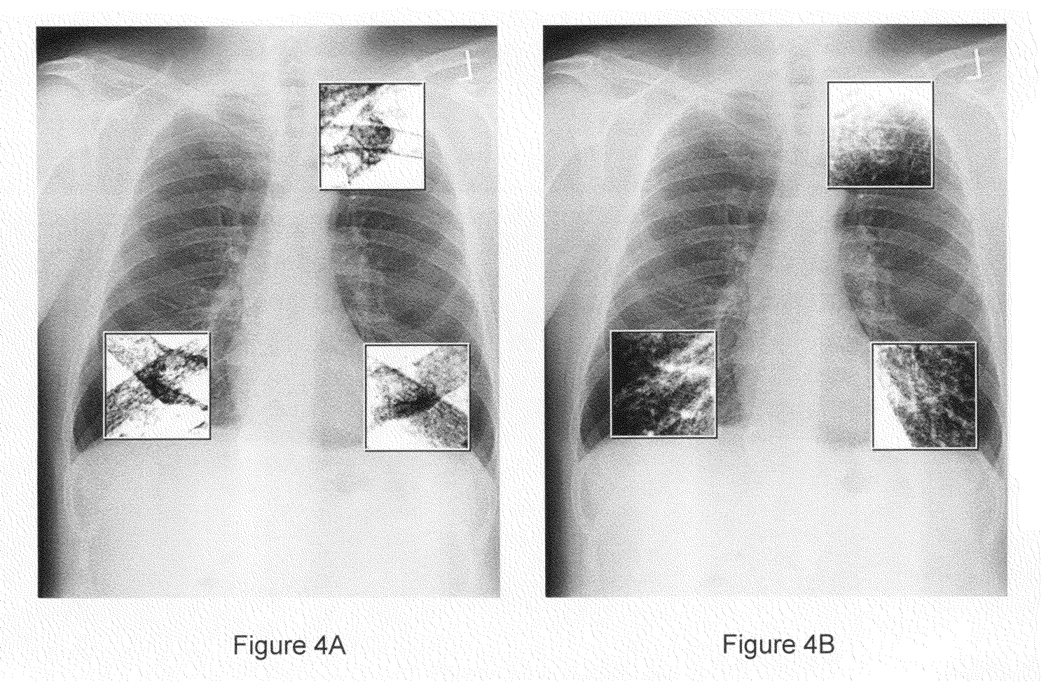

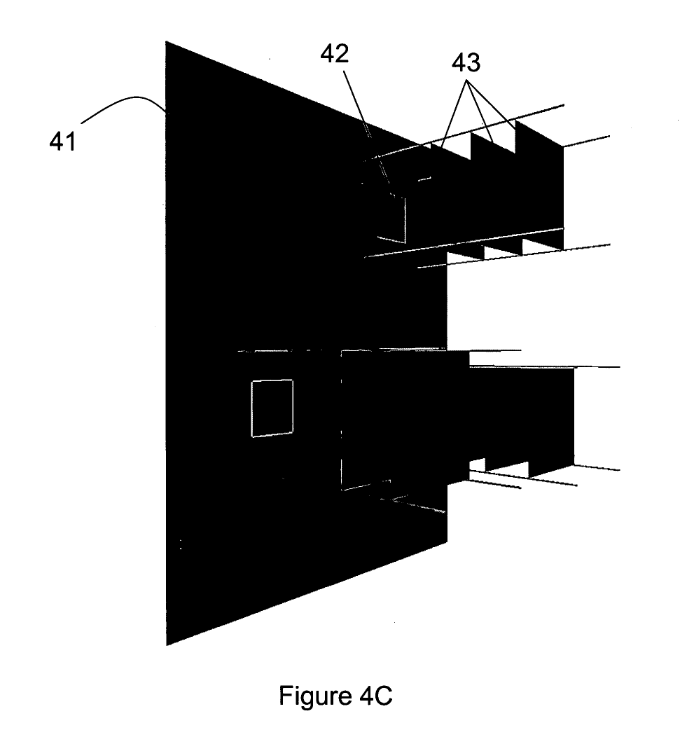

This concept may be extended, in some embodiments of the invention, by allowing further scrolling (or other selecting) to present alternative chip content based on other images that may be registered. Examples of such additional chip content may include, but are not limited to, regular image with CAD; a soft-tissue image based on dual-energy techniques; a bone image based on dual-energy techniques, and/or a soft-tissue image generated from a regular image using software-based techniques (which may be called, e.g., a “virtual soft-tissue image,” and which may be generated by known techniques (such as the MTANN method developed at the University of Chicago) or by techniques as yet to be discovered). For example, FIG. 4A shows an exemplary image in which the ROI chips contain dual energy bone images, and FIG. 4B shows an exemplary image in which the ROI chips contain soft-tissue images. Other display options may also include, for example, CAD-calculated contours or enhancements for additional chip content.

FIG. 4C shows a conceptual depiction of an embodiment of the above-described concept. For an image 41, a number of different types of views/images 43 may be associated with a particular ROI 42. Embodiments of the invention may permit a user to select and/or to scroll through the various views/images 43, which may allow for time-efficient and convenient comparisons. In other embodiments of the invention, the various views/images 43 may automatically be displayed one after another, without user intervention. The user may be provided with the ability to stop and/or to resume this automatic cycling through the various views/images.

In some embodiments of the invention, after the default presentation of the ROI chips, the user may be permitted to drag, or otherwise move, them to other locations in the image, e.g., as multiple magnifiers (e.g., for the same ROI).

An alternative presentation, which may be used in some embodiments of the invention, is to show each magnified ROI only one at a time with a user interaction to move forward/backward through the ROIs. This may be used to address the possible issue of overlapping ROIs. In some embodiments of the invention, the display system may create a larger magnified ROI chip to encompass all of the overlapping ROIs (when they are too close to display as individual ROI chips.

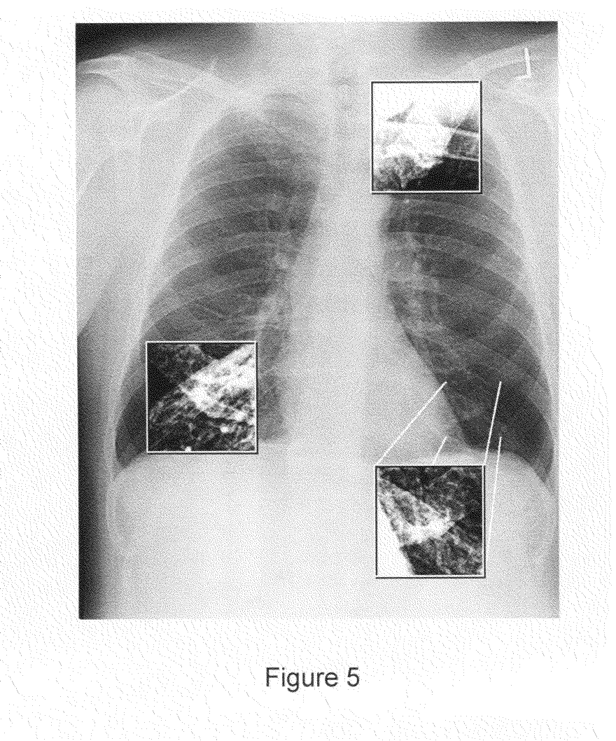

As an extension of this concept, in some embodiments of the invention, a user may double click (or similarly select in a manner that may differ from the selection of a display mode) any location within the image and can bring up an ROI chip optimally windowed/leveled for that location. In a further embodiment, the ROI chip thus generated may be dragged, or otherwise moved, across the image with dynamic updating according to the image area below, or it may be “frozen” and dragged, or otherwise moved, to a new location with connectors to show its origin location. An example of this latter display technique is shown in FIG. 5 (where the connectors are shown for the ROI chip in the lower right-hand portion of the image).

As a further extension of these techniques, the number of presented ROI chips may be limited by using CAD detection scores such that scrolling the mouse wheel (or other manual selection action) may be used to vary the number of ROI chips from a maximum number to a minimum number. This may correspond, for example, to stepping along the free receiver operating characteristic (FROC) curve to obtain a variable sensitivity/false positive per image (FPPI) operating point.

In some embodiments of the invention, hovering the mouse over the ROI chip, or similarly manually selecting it, may be customized to cause display of textual information related to the ROI. Such information may include, but is not limited to size, features, etc.

Furthermore, in some embodiments of the invention, a menu or other GUI selection scheme may be provided to permit a user to select such per-chip options as freeze/unfreeze (toggle), enable contour, add to DICOM-structured report, etc. Such a menu may be obtained, for example, by means of a right mouse click or other manual selection method.

As discussed above, in some embodiments of the invention, the windowing/leveling for an ROI chip may have been, in some way, automatically optimized. However, it may be useful for a user to be able to change the windowing/leveling, to contrast with the automatically optimized view. In some embodiments of the invention, there may also be provided additional images having different windowing/leveling settings for one or more ROI chips (and this may be a user-selectable option, e.g., for a particular ROI chip or for an image), and the user may be able to scroll through and/or otherwise select among these alternatively-windowed/leveled images. In one exemplary implementation of such an embodiment, the differently-windowed/leveled images may be provided for all ROI chips of a given image, and the user may be able to select among the differently-windowed/leveled images for all ROI chips, simultaneously; alternatively, it may be possible to select a single ROI chip and perform this for just that ROI chip.

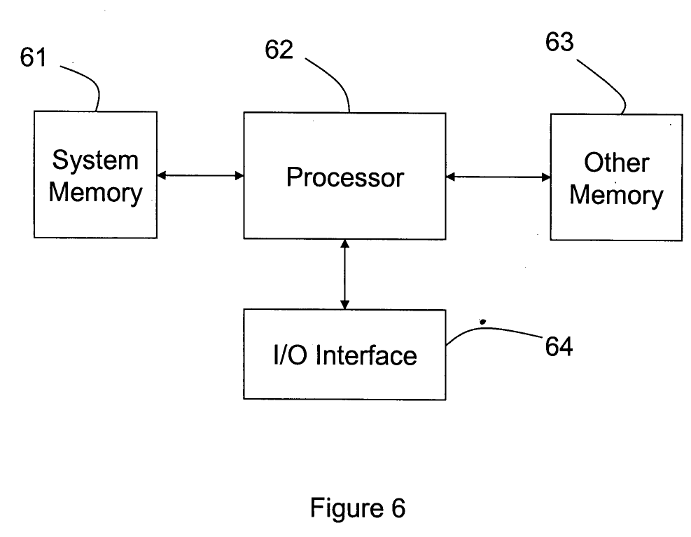

Various embodiments of the invention may comprise hardware, software, and/or firmware. FIG. 6 shows an exemplary system that may be used to implement various forms and/or portions of embodiments of the invention. Such a computing system may include one or more processors 62, which may be coupled to one or more system memories 61. Such system memory 61 may include, for example, RAM, ROM, or other such machine-readable media, and system memory 61 may be used to incorporate, for example, a basic I/O system (BIOS), operating system, instructions for execution by processor 62, etc. The system may also include further memory 63, such as additional RAM, ROM, hard disk drives, or other processor-readable media. Processor 62 may also be coupled to at least one input/output (I/O) interface 64. I/O interface 64 may include one or more user interfaces, as well as readers for various types of storage media and/or connections to one or more communication networks (e.g., communication interfaces and/or modems), from which, for example, software code may be obtained.

Various embodiments of the invention have been presented above. However, the invention is not intended to be limited to the specific embodiments presented, which have been presented for purposes of illustration. Rather, the invention extends to functional equivalents as would be within the scope of the appended claims. Those skilled in the art, having the benefit of the teachings of this specification, may make numerous modifications without departing from the scope and spirit of the invention in its various aspects.

We claim:

1. A method of displaying one or more regions of interest within a radiological image, comprising:
displaying the radiological image; and
superimposing on the radiological image one or more of the regions of interest, wherein the one or more regions of interest are superimposed in one or more locations in the radiological image to which they correspond, and wherein the one or more regions of interest are displayed as magnified sub-images with respect to the radiological image.

2. The method according to claim 1, wherein each region of interest is independently windowed and leveled according to parameters determined for the particular region of interest.

3. The method according to claim 1, wherein each region of interest is independently magnified according to one or more parameters determined for the particular region of interest.

4. The method according to claim 1, further comprising:
enabling a user to select, for one or more regions of interest, at least one display option selected from the group consisting of a magnification, a windowing level, and a leveling level.

5. The method according to claim 1, further comprising:
enabling a user to select among multiple images registered for a given region of interest.

6. The method according to claim 5, wherein said multiple images are selected from the group consisting of: an image having windowing, leveling, and magnification according to one or more parameters determined for the given region of interest; a soft-tissue image; a bone image; and a color-inverted image.

7. The method according to claim 1, further comprising:
enabling a user to move a displayed region of interest to another location.

8. The method according to claim 7, wherein said enabling includes providing a graphical indication of the location to which a moved region of interest corresponds.

9. The method according to claim 1, further comprising:
enabling a user to select a number of regions of interest to be displayed.

10. The method according to claim 1, further comprising:
downloading software to implement said displaying and said superimposing.

11. The method according to claim 1, further comprising:
automatically cycling through a sequence of images registered for at least one region of interest.

12. A processor-readable medium containing instructions that, when executed by a processor, cause the processor to implement a method of displaying one or more regions of interest within a radiological image, the method comprising:
displaying the radiological image; and
superimposing on the radiological image one or more of the regions of interest, wherein the one or more regions of interest are superimposed in one or more locations in the radiological image to which they correspond, and wherein the one or more regions of interest are displayed as magnified sub-images with respect to the radiological image.

13. The medium according to claim 12, wherein each region of interest is independently windowed and leveled according to parameters determined for the particular region of interest.

14. The medium according to claim 12, wherein each region of interest is independently magnified according to one or more parameters determined for the particular region of interest.

15. The medium according to claim 12, wherein the method further comprises:
enabling a user to select, for one or more regions of interest, at least one display option selected from the group consisting of a magnification, a windowing level, and a leveling level.

16. The medium according to claim 12, wherein the method further comprises:
enabling a user to select among multiple images registered for a given region of interest.

17. The medium according to claim 16, wherein said multiple images are selected from the group consisting of: an image having windowing, leveling, and magnification according to one or more parameters determined for the given region of interest; a soft-tissue image; a bone image; and a color-inverted image.

18. The medium according to claim 12, wherein the method further comprises:
enabling a user to move a displayed region of interest to another location.

19. The medium according to claim 18, wherein said enabling includes providing a graphical indication of the location to which a moved region of interest corresponds.

20. The medium according to claim 12, wherein the method further comprises:
enabling a user to select a number of regions of interest to be displayed.

21. The medium according to claim 12, wherein the method further comprises:
automatically cycling through a sequence of images registered for at least one region of interest.

22. A system comprising:
a computer-aided detection (CAD) processing module to process at least one radiological image and to identify one or more regions of interest; and
a display processing module to display a radiological image and to superimpose on the radiological image one or more of the regions of interest, wherein the one or more regions of interest are to be superimposed in one or more locations in the radiological image to which they correspond, and wherein the one or more regions of interest are to be displayed as magnified sub-images with respect to the radiological image.

23. The system according to claim 22, further comprising:
a user interface to permit a user to select among various options for one or more of the regions of interest by means of scrolling, clicking, or other non-keyboard techniques.

24. The system according to claim 23, wherein said user interface includes a graphical user interface selection scheme.

25. The system according to claim 23, wherein said various options include one or more options selected from the group consisting of: magnification; windowing; leveling; a corresponding registered image; a color-inverted image; brightness; and contrast.
